(19) United States
(12) Patent Application Publication
(10) Pub. No.: US 2012/0180053 A1
(43) Pub. Date: Jul. 12, 2012

(54) CALL STACK AGGREGATION AND DISPLAY

(75) Inventors: Eric Lawrence Barsness, Pine Island, MN (US); John Matthew Santosuosso, Rochester, MN (US)

(73) Assignee: INTERNATIONAL BUSINESS MACHINES CORPORATION, Armonk, NY (US)

(21) Appl. No.: 12/987,262

(22) Filed: Jan. 10, 2011

(51) Int. Cl. G06F 9/46

(52) U.S. Cl. 718/101

(57) ABSTRACT

A call stack aggregation mechanism aggregates call stacks from multiple threads of execution and displays the aggregated call stack to a user in a manner that visually distinguishes between the different call stacks in the aggregated call stack. The multiple threads of execution may be on the same computer system or on separate computer systems.

### BACKGROUND

1. Technical Field

This disclosure generally relates to computer systems, and more specifically relates to display of call stacks in computer systems.

2. Background Art

As the complexity of computer programs increase, the more difficult they are to debug. Debugging a computer program is a process of finding problems, or “bugs”, that cause the computer program to function incorrectly. Debuggers are often used to debug computer programs. Known debuggers typically include functions that allow stopping execution of a program at a particular point known as a breakpoint, then analyzing the state of the computer program. The state of a computer program may include call stacks. A call stack is a data structure that provides a last-in-first-out (LIFO) function. Thus, when data is written to the call stack, it is “pushed” onto the call stack, and when data is read from the call stack, the most recently written data is “popped” off the call stack. Call stacks are known by different terms in different programming environments, including execution stack, control stack, function stack, or run-time stack. For the purposes of this disclosure, the term “call stack” extends to any data structure that contains information about the state of a computer program, regardless of the particular name used. The most common usage of the term “call stack” refers to a stack that holds a list of current subroutines invoked by threads running a computer program.

Modern computer programs often interact with other computer programs to accomplish some desired functionality. For example, if a user using a web browser wants to access data on a website, the user might send a command via the browser to a hypertext transfer protocol (HTTP) server on a first computer system, which might invoke an application server such as IBM's WebSphere Application Server on a second computer system, which might interact with a database server on a third computer system. Known debuggers and performance monitors allow displaying a call stack for a single thread of execution. However, when multiple cooperating threads are involved, especially across multiple different computer systems, looking at a call stack for a single thread often does not give a clear picture of what is going on. Without a way to aggregate and display call stack information from multiple threads, performing debug and performance monitoring across multiple threads will be difficult.

### BRIEF SUMMARY

A call stack aggregation mechanism aggregates call stacks from multiple threads of execution and displays the aggregated call stack to a user in a manner that visually distinguishes between the component call stacks in the aggregated call stack. The multiple threads of execution may be on the same computer system or on separate computer systems.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of an apparatus that includes a call stack aggregation mechanism that aggregates call stacks from multiple programs into an aggregated call stack;

FIG. 2 is a flow diagram of a prior art method for displaying a single call stack for a single thread;

FIG. 3 is a flow diagram of a method for aggregating multiple call stacks and displaying the aggregated call stack;

FIG. 4 shows three threads that interact, and that each have their own call stack;

FIG. 5 is a prior art display of the single call stack for Thread 1 in FIG. 4;

FIG. 6 is a prior art display of the single call stack for Thread 2 in FIG. 4;

FIG. 7 is a prior art display of the single call stack for Thread 3 in FIG. 4;

FIG. 8 is a display of an aggregated call stack that includes all three call stacks shown in FIG. 4;

FIG. 9 is a flow diagram of a method for aggregating multiple call stacks and displaying the aggregated call stack based on a selection of data;

FIG. 10 is an example showing different operators that operate simultaneously on the same data;

FIG. 11 is a sample display of an aggregated call stack that includes multiple call stacks related to selected data;

FIG. 12 is a sample system configuration;

FIG. 13 shows sample information stored on Call Stack P for Thread P in FIG. 12;

FIG. 14 shows sample information stored on Call Stack Q for Thread Q in FIG. 12;

FIG. 15 shows sample information stored on Call Stack R for Thread R in FIG. 12; and

FIG. 16 shows a display of an aggregated call stack that includes Call Stack P, Call Stack Q and Call Stack R.

### DETAILED DESCRIPTION

The claims and disclosure herein provide a call stack aggregation mechanism that aggregates call stacks from multiple threads into a single aggregated call stack. The aggregated call stack may then be displayed to a user in a way that visually distinguishes between the different component call stacks in the aggregated call stack.

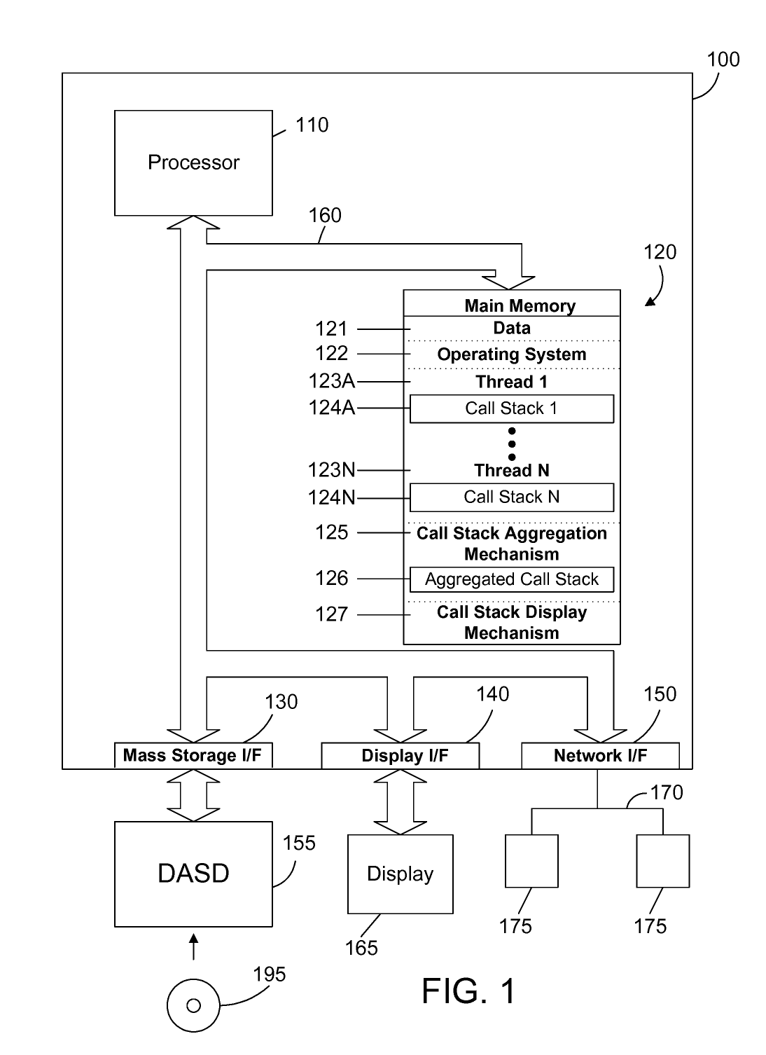

Referring to FIG. 1, a computer system 100 is one suitable implementation of a computer system that includes a call stack aggregation mechanism. Computer system 100 is an IBM eServer System i computer system. However, those skilled in the art will appreciate that the disclosure herein applies equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD-RW drive, which may store data to and read data from a CD-RW 195.

Main memory 120 preferably contains data 121, an operating system 122, multiple threads (shown in FIG. 1 as thread 123A, . . . , thread 123N), a call stack aggregation mechanism 125 and a call stack display mechanism 127. Data 121 represents any data that serves as input to or output from any program in computer system 100. Operating system 122 is a multitasking operating system. Each thread includes its own call stack. Thus, call stack 123A includes a corresponding call stack 124A; and so on through call stack 123N including a corresponding call stack 124N. The call stack aggregation mechanism 125 generates from multiple individual call stacks from multiple threads an aggregated call stack 126. The call stack display mechanism 127 displays the aggregated call stack 126 in a way that visually distinguishes between the component call stacks that are stored in the aggregated call stack 126. One suitable visual indication uses color. Thus, information from a first call stack could be shown in blue, information from a second call stack could be shown in green, and information from a third call stack could be shown in red. The color could be used to color the text on the call stack, to color a rectangle or other shape surrounding the text on the call stack, to provide colored brackets or bars, etc. Many other suitable visual indications could be used, including text size, font, white spaces between call stacks in the aggregated call stack, labels, etc. The disclosure and claims herein expressly extend to any suitable way to visually distinguish between component call stacks in the aggregated call stack, whether currently known or developed in the future.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, threads 123A, . . . , 123N, call stack aggregation mechanism 125, and call stack display mechanism 127 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Processor 110 also executes the threads 123A, . . . , 123N, the call stack aggregation mechanism 125 and the call stack display mechanism 127.

Although computer system 100 is shown to contain only a single processor and a single system bus, those skilled in the art will appreciate that a call stack aggregation mechanism may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to provide system administrators and users the ability to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect computer system 100 to other computer systems or workstations 175 via network 170. Network interface 150 broadly represents any suitable way to interconnect electronic devices, regardless of whether the network 170 comprises present-day analog and/or digital techniques or via some networking mechanism of the future. Network interface 150 preferably includes a combination of hardware and software that allow communicating on the network 170. Software in the network interface 150 preferably includes a communication manager that manages communication with other computer systems 175 via network 170 using a suitable network protocol. Many different network protocols can be used to implement a network. These protocols are specialized computer programs that allow computers to communicate across a network. TCP/IP (Transmission Control Protocol/Internet Protocol) is an example of a suitable network protocol that may be used by the communication manager within the network interface 150.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the computer system 100 in FIG. 1 shows multiple threads 123A, . . . , 123N on a single computer system 100 for the sake of illustration, the same principles equally apply to a distributed computing environment. In other words, the threads could span multiple computer systems. The call stack aggregation mechanism 125 and call stack display mechanism 127 could reside on one computer system, or could be defined across multiple computer systems. The disclosure and claims herein expressly extend to aggregating call stacks across multiple threads from any suitable combination of hardware and software in any suitable configuration.

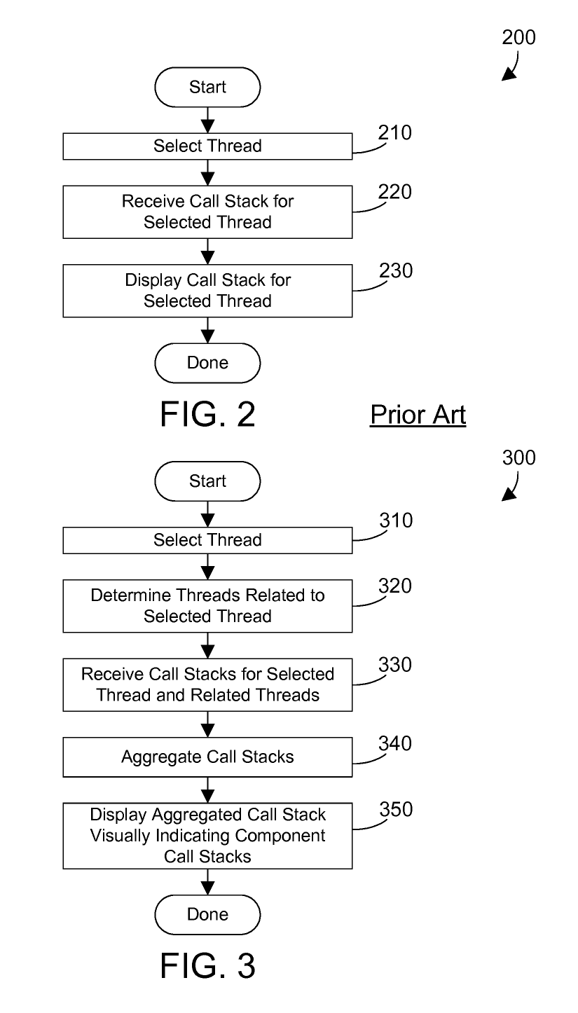

Referring to FIG. 2, a prior art method 200 shows how a single call stack may be displayed in the prior art. A thread of execution is selected (step 210). The call stack for the selected thread is then received (step 220) and displayed (step 230). Note the step of receiving the call stack in step 220 may be as simple as reading the call stack from memory. Prior art method 200 shows displaying only a single call stack.

Referring to FIG. 3, a method 300 begins by selecting a thread of execution (step 310). One suitable way to select a thread is for a user to perform some function in a graphical user interface to select the thread, such as double-clicking on an icon representing the thread or selecting the thread from a drop-down list. Next, threads related to the selected thread are determined (step 320). Note that threads may be related using various different criteria. For example, two threads may be related if there is exchange of data between the threads. In another example, two threads may be related if a first thread must finish a job before the second thread can perform its function. Of course, various other criteria may be used to determine whether two threads are related, whether currently known or developed in the future. Once the related threads are determined, the call stacks for the selected thread and the related threads are received (step 330). The call stacks for the selected thread and the related threads are then aggregated into a single aggregated call stack (step 340). The single aggregated call stack includes the call stack for the selected thread as well as the call stacks for the related threads. The aggregated call stack is then displayed in a manner that visually indicates the different call stacks in the aggregated call stacks (step 350). For the purpose of this disclosure, the call stacks that are in an aggregated call stack are referred to herein as a “component call stacks.” As discussed above, any suitable method for visually differentiating between the component call stacks are within the scope of the disclosure and claims herein, whether currently known or developed in the future.

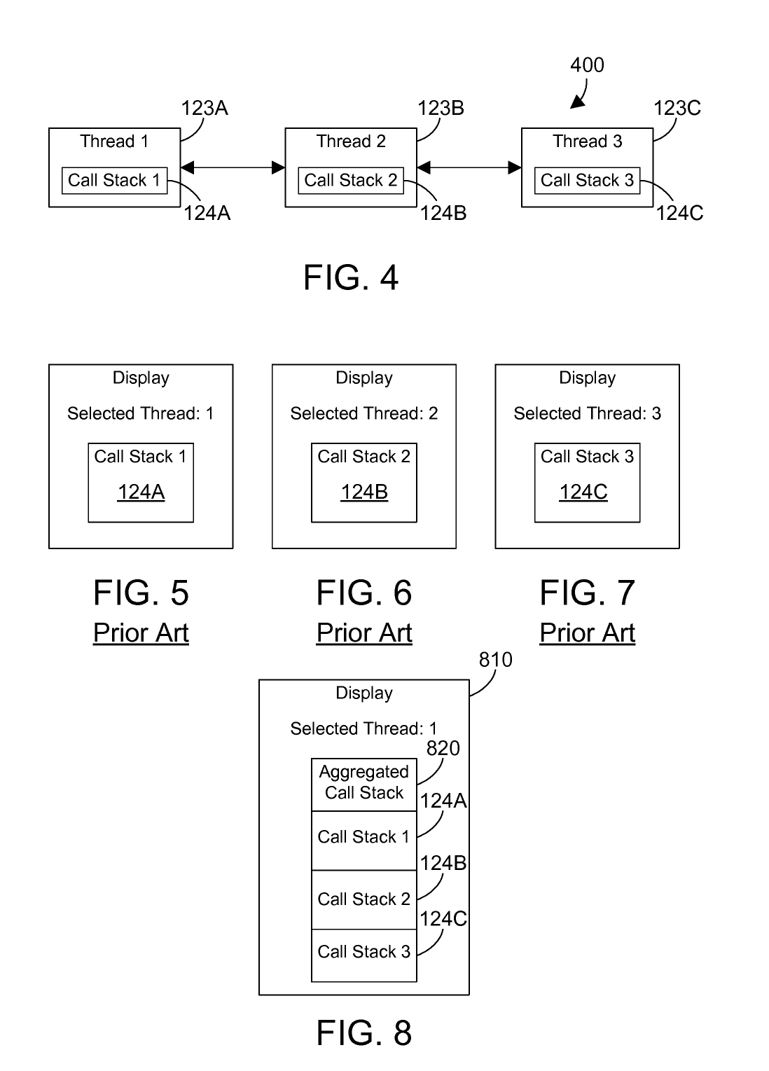

FIG. 4 shows a diagram of a sample system 400 that illustrates three threads that exchange data. These threads could be on the same computer system, or could be located on two or more different computer systems. We assume for this example the three threads are related because they exchange data with each other. While the relation between Thread 1 123A and Thread 2 123B is clear because they directly exchange data (as indicated by the arrow between them), and while the relation between Thread 2 123B and Thread 3 123C is similarly clear because they directly exchange data, we further assume Thread 1 123A is also related to Thread 3 123C because Thread 1 123A receives data from Thread 3 123C via Thread 2 123B. Each thread has a corresponding call stack. Thus, Thread 1 123A includes a call stack 124A; Thread 2 123B includes a call stack 124B; and Thread 3 123C includes a call stack 124C. According to prior art method 200 in FIG. 2, a user could select Thread 1 123A (step 210), and in response, the call stack 124A corresponding to thread 1 is received (step 220) and displayed (step 230), as shown in FIG. 5. A user could also select Thread 2 123B (step 210), and in response, the call stack 124B corresponding to thread 2 is received (step 220) and displayed (step 230), as shown in FIG. 6. A user could also select Thread 3 123C (step 210), and in response, the call stack 124C corresponding to thread 3 is received (step 220) and displayed (step 230), as shown in FIG. 7. Note in the prior art, a single thread is selected, and only the call stack for that thread is displayed.

Now we apply method 300 in FIG. 3 to the same sample system 400 shown in FIG. 4. We assume for this example the user selects Thread 1 (step 310), as shown in the display 810 in FIG. 8. In response, the threads related to the selected thread are determined (step 320). For the example in FIG. 4, Thread 2 123B and Thread 3 123C are both related to Thread 1 123A. The call stacks for the selected thread and related threads are received (step 330). The three call stacks are aggregated into an aggregated call stack (step 340). The aggregated call stack is then displayed in a manner that visually indicates component call stacks (step 350), and is shown in FIG. 8 as aggregated call stack 820. The visual indication in FIG. 8 consists of lines that divide the aggregated call stack into its component call stacks. Color is now shown in the drawings because the drawings are black and white. Note the aggregated call stack 820 displayed in FIG. 8 is one suitable example of aggregated call stack 126 shown in FIG. 8. Method 300 thus results in the display of an aggregated call stack 820 that includes three component call stacks 124A, 124B and 124C, as shown in FIG. 8.

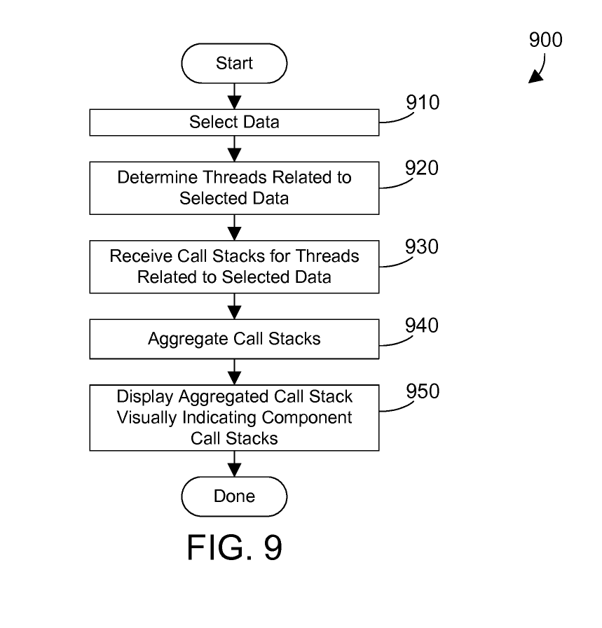

In a second implementation, instead of selecting a thread and determining related threads, instead the user selects data of interest. Referring to FIG. 9, the user selects data (step 910). The threads related to the selected data are determined (step 920). The call stacks for the threads related to the selected data are received (step 930). The call stacks of the related threads are aggregated into an aggregated call stack (step 940). The aggregated call stack is then displayed in a manner that visually indicates component call stacks (step 950). In this case, the aggregation is not intended to show a continuous flow of execution for multiple threads doing one piece of work, but instead will show multiple threads of execution interacting with the data.

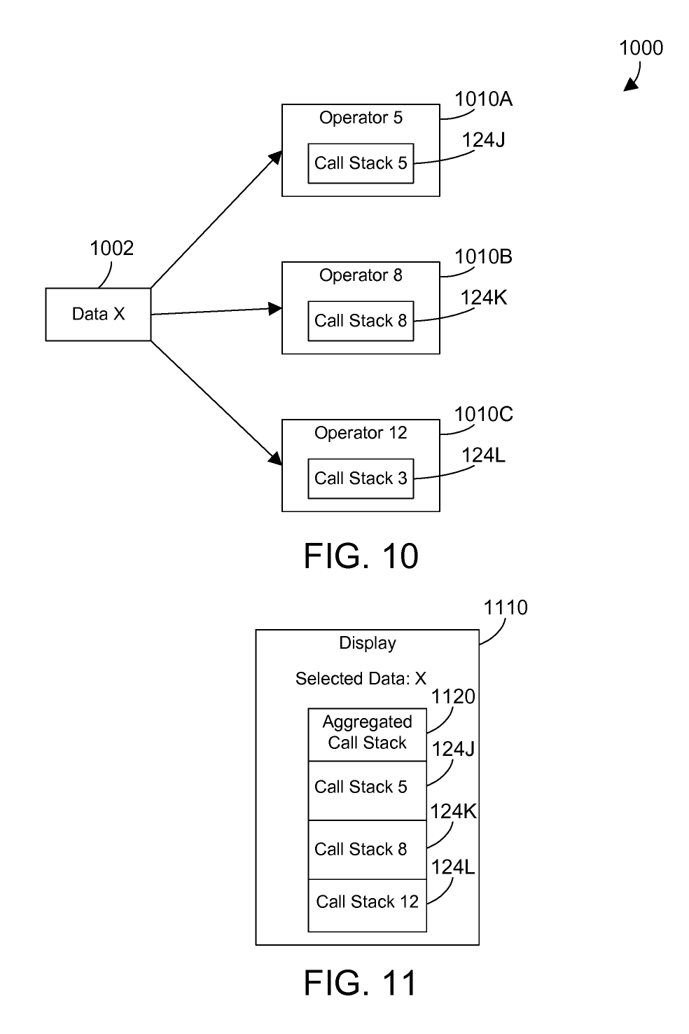

A simple example will illustrate. A sample system 1000 is shown in FIG. 10. This system processes incoming streaming data. We assume data X 1002 is processed simultaneously by three operators 1010A, 1010B and 1010C. Each operator includes a corresponding call stack. Thus, operator 1010A includes a call stack 124J; operator 1010B includes a call stack 124K; and operator 1010C includes a call stack 124L.

We assume a user wants to examine threads that operate on data X 1002. We further assume the operators shown in FIG. 10 represent threads. Using method 900 in FIG. 9, the user can select data X 1002 (step 910). For this example, we assume this is done via a graphical user interface. The display 1110 in FIG. 11 shows that data X is selected. The threads related to the selected data are then determined (step 920). In the example in FIG. 10, the three operators 1010A, 1010B and 1010C all operate on data X 1002, and are therefore related to data X 1002. The call stacks for the three related threads are received (step 930), then aggregated into an aggregated call stack (step 940). The aggregated call stack is then displayed in a manner that visually indicates component call stacks (step 950). The display of the aggregated call stack 1120 is shown in FIG. 11 to include the component calls stacks 124J, 124K and 124L that correspond to the threads related to the selected data.

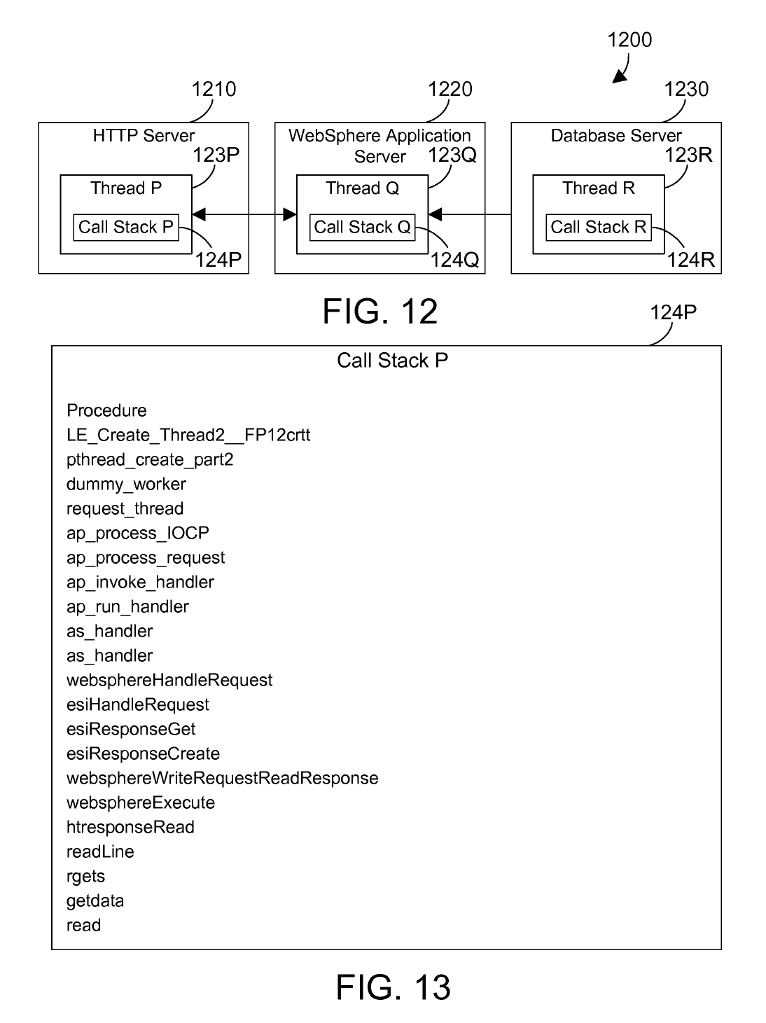

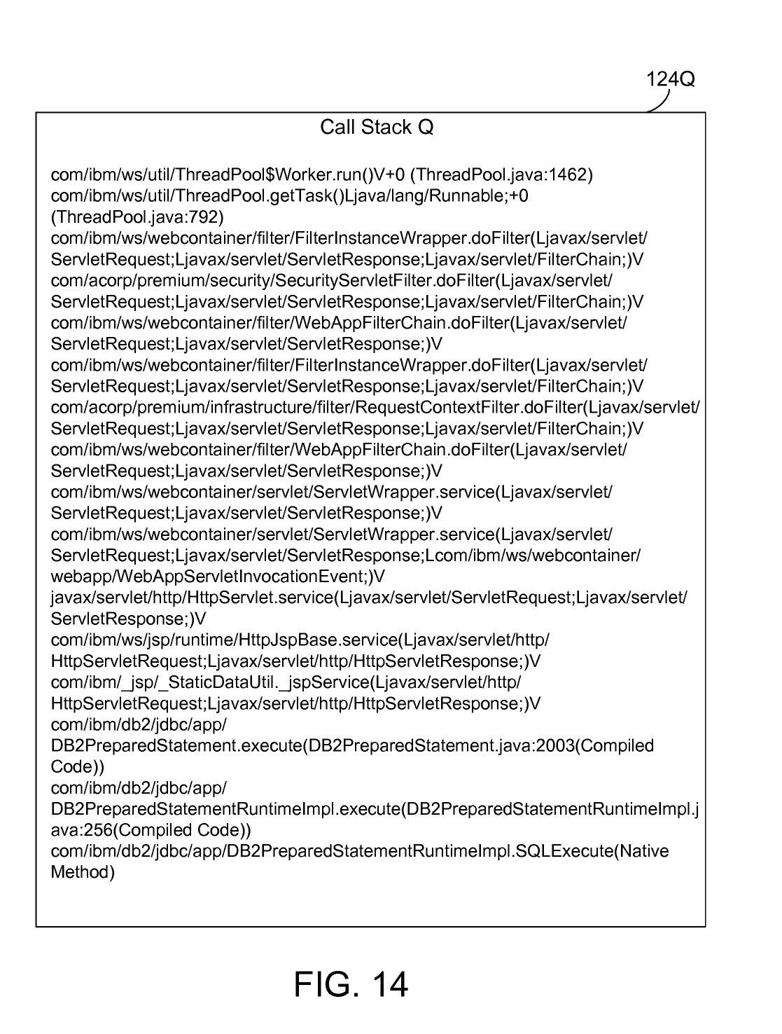

A specific example is now provided to illustrate many of the concepts discussed generally above. A sample system 1200 is shown in FIG. 12, and includes an HTTP server 1210, a WebSphere Application Server 1220, and a Database Server 1230. The HTTP server 1210 includes a thread 123P with a corresponding call stack 124P. The WebSphere Application Server 1220 includes a thread 123Q with a corresponding call stack 124Q. The database server 1230 includes a thread 123R with a corresponding call stack 124R. We assume a request is made to the HTTP server 1210 to access data in the database server 1230. The way the HTTP server 1210 handles the request is to call the WebSphere Application Server 1220, which then calls the database server 1230. A sample call stack 124P in the HTTP server 1210 is shown in FIG. 13, and includes information regarding requests being service by the thread 123P. A sample call stack 124Q in the WebSphere Application Server 1220 is shown in FIG. 14, and includes information regarding requests being serviced by the thread 123Q. A sample call stack 124R in the Database Server 1230 is shown in FIG. 14, and includes information regarding requests being serviced by the thread 123R. Note the different threads in system 1200 shown in FIG. 12 reside on different physical computers systems.

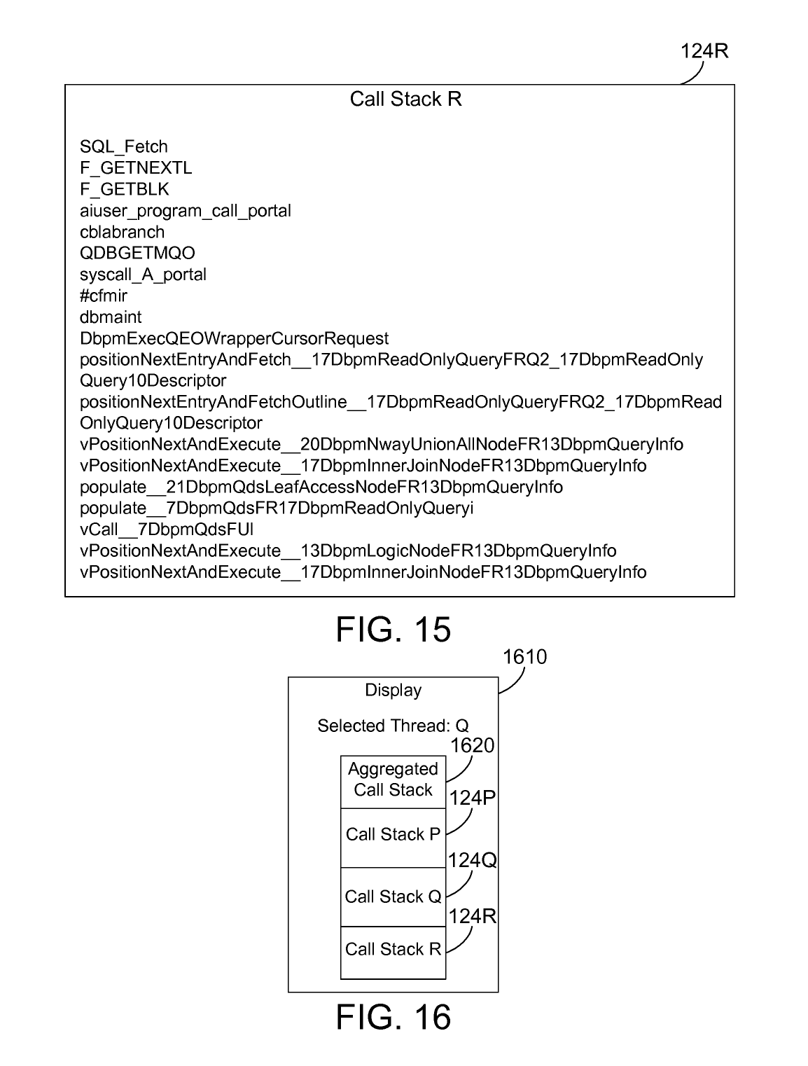

Now we apply the method 300 in FIG. 3 to the sample system 1200 in FIG. 12. A user selects a thread (step 310). We assume the user selects thread Q 123Q in the WebSphere Application Server 1220, as shown in the display 1610 in FIG. 16. Next, the threads related to thread 123Q are determined (step 320). We assume for this example threads 123P and 123R are related to thread 123Q. Next, the call stacks for the selected thread and related threads are received (step 330). The sample call stacks are shown in FIGS. 13-15. These three call stacks are then aggregated into an aggregated call stack (step 340), which is displayed in a way that visually indicates the component call stacks (step 350). In the display 1610 in FIG. 16, the aggregated call stack 1620 includes the three component call stacks 124P, 124Q and 124R, as shown. The visual indication in display 1610 is once again simple lines separating the component call stacks so the user can visually discern the component call stacks.

While the display 1610 in FIG. 16 shows all three call stacks 124P, 124Q and 124R displayed at the same time, one skilled in the art will recognize that known display techniques could be used to display only portions of a call stack, or only a portion (or window) of the aggregated call stack. Thus, the display of each component call stack could include a limited display area with scroll bars to allow viewing portions outside the display area. In addition, or in the alternative, the aggregated call stack 1610 could have one or more scroll bars as well. The disclosure and claims expressly extend to the aggregation of call stacks into an aggregated call stack, and the display of the aggregated call stack in a manner that distinguishes between the component call stacks. For example, the call stacks could be so large that only a portion of one call stack is visible at any given time, but the different component call stacks could be color-coded so the user will know from the color of the call stack which call stack is currently displayed.

The disclosure and claims are directed to a call stack aggregation mechanism that aggregates call stacks from multiple threads of execution and displays the aggregated call stack to a user in a manner that visually distinguishes between the different component call stacks in the aggregated call stack. The multiple threads of execution may be on the same computer system or on separate computer systems.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor;
a first thread of execution and corresponding first call stack residing in the memory;
a second thread of execution and corresponding second call stack residing in the memory;
a call stack aggregation mechanism residing in the memory and executed by the at least one processor, the call stack aggregation mechanism generating an aggregated call stack that includes the first call stack and the second call stack; and
a call stack display mechanism residing in the memory and executed by the at least one processor, the call stack display mechanism displaying the aggregated call stack in a manner that visually distinguishes between the first call stack and the second call stack.

2. The apparatus of claim 1 wherein the call stack display mechanism displays the first call stack and the second call stack in the aggregated call stack in different colors.

3. The apparatus of claim 1 wherein the call stack aggregation mechanism receives a selection of a third thread from a user and determines the first and second threads are related to the third thread, and in response, generates the aggregated call stack that includes the first call stack and the second call stack.

4. The apparatus of claim 1 wherein the call stack aggregation mechanism receives a selection of data from a user and determines the first and second threads are related to the selected data, and in response, generates the aggregated call stack that includes the first call stack and the second call stack.

5. The apparatus of claim 1 wherein the first thread and the second thread are executed on the same computer system.

6. The apparatus of claim 1 wherein the first thread and the second thread are executed on different computer systems.

7. A computer-implemented method executed by at least one processor for displaying call stack information to a user, the method comprising the steps of:
(A) receiving from the user a selection;
(B) determining a first thread and a second thread are related to the selection in step (A);
(C) receiving a first call stack corresponding to the first thread;
(D) receiving a second call stack corresponding to the second thread;
(E) aggregating the first call stack and the second call stack into an aggregated call stack; and
(F) displaying the aggregated call stack in a manner that visually distinguishes between the first call stack and the second call stack.

8. The method of claim 7 wherein step (F) displays the first call stack and the second call stack in the aggregated call stack in different colors.

9. The method of claim 7 wherein the user selection received in step (A) comprises a selection of a third thread by the user.

10. The method of claim 7 wherein the user selection received in step (A) comprises a selection of data by the user.

11. The method of claim 7 wherein step (C) receives the first call stack from a first computer system executing the first thread and step (D) receives the second call stack from the first computer system executing the second thread.

12. The method of claim 7 wherein step (C) receives the first call stack from a first computer system executing the first thread and step (D) receives the second call stack from a second computer system executing the second thread that is separate from the first computer system.

13. A computer-implemented method executed by at least one processor for displaying call stack information to a user, the method comprising the steps of:
(A) receiving from the user a selection of a first thread;
(B) determining a second thread and a third thread are related to the first thread selected in step (A);
(C) receiving from a first computer system a second call stack corresponding to the second thread;
(D) receiving from the first computer system a third call stack corresponding to the third thread;
(E) aggregating the second call stack and the third call stack into a first aggregated call stack;
(F) displaying the first aggregated call stack in a manner that visually distinguishes using color between the second call stack and the third call stack;
(G) receiving from the user a selection of a data;
(H) determining a fourth thread and a fifth thread are related to the data selected in step (G);
(I) receiving from the first computer system a fourth call stack corresponding to the fourth thread;
(J) receiving from a second computer system a fifth call stack corresponding to the fifth thread;
(K) aggregating the fourth call stack and the fifth call stack into a second aggregated call stack; and
(L) displaying the second aggregated call stack in a manner that visually distinguishes using color between the fourth call stack and the fifth call stack.

14. An article of manufacture comprising software stored on a computer readable storage medium, the software comprising:
a call stack aggregation mechanism that generates an aggregated call stack that includes a first call stack corresponding to a first thread of execution and a second call stack corresponding to a second thread of execution; and
a call stack display mechanism that displays the aggregated call stack in a manner that visually distinguishes between the first call stack and the second call stack.

15. The article of manufacture of claim 14 wherein the call stack display mechanism displays the first call stack and the second call stack in the aggregated call stack in different colors.

16. The article of manufacture of claim 14 wherein the call stack aggregation mechanism receives a selection of a third thread from a user and determines the first and second threads are related to the third thread, and in response, generates the aggregated call stack that includes the first call stack and the second call stack.

17. The article of manufacture of claim 14 wherein the call stack aggregation mechanism receives a selection of data from a user and determines the first and second threads are related to the selected data, and in response, generates the aggregated call stack that includes the first call stack and the second call stack.

18. The article of manufacture of claim 14 wherein the first thread and the second thread are executed on the same computer system.

19. The article of manufacture of claim 14 wherein the first thread and the second thread are executed on different computer systems.
